(19) United States
(12) Patent Application Publication
(10) Pub. No.: US 2006/0162666 A1
(43) Pub. Date: Jul. 27, 2006

(54) Decorative animal litter box enclosure

(76) Inventor: Jerri Mitchell, Oak Brook, IL (US)

Correspondence Address: JoAnne M. Denison, Suite 2004, 212 W. Washington Blvd, Chicago, IL, 60606, US

(21) Appl. No.: 11/041,809

(22) Filed: Jan. 21, 2005

(51) Int. Cl. A01K 1/035

(52) U.S. Cl. 119/168

(57) ABSTRACT

A decorated animal litter box enclosure for camouflaging an animal litter box or bedding area comprising one integral corrugated unit which can be configured along corrugated lines to create at least three upstanding sidewall sections. The outer section of the enclosure may be decorated. Further, the upstanding sidewall sections can be provided with at least one base flaps which can be tucked under the litter box or bedding chamber to provide rigidity and support. The upper surface of the upstanding sidewall sections may be provided with a support and/or stabilizing means and/or a support means, both of which also provide rigidity and support for the configuration of the enclosure. The base flaps, support means, and support and/or stabilizing means may all be used separately or in conjunction with one another and may be easily and quickly installed and removed for disassembly and storage or disposal.

### FIELD OF THE INVENTION

The present invention relates to the field of decorative screening devices for animal, cat, and kitten litter pans and bedding areas, and more particularly those that have easily constructed and inexpensive upstanding sidewalls.

### BACKGROUND OF THE INVENTION

Currently, in the marketplace, there are available a wide variety of cat litter box covers that are designed to enclose the ugliness, mess, and smell of a litter box, which is disagreeable to cat owners. Oftentimes, a cat litter box must be placed in the area of a home wherein the cat litter box is visible to the home owner and to visitors. No one wants to watch a cat or other animal using a litter box, and by the same token, animals tend to enjoy privacy while resting or using the litter box. Over recent years, home owners have purchased more valuable and expensive items for their pets such as hand pointed pet beds and furniture. In a living room in particular, home owners greatly desire to have each item of furniture to be highly decorative and uniquely made. Although cat owners have ingeniously devised various means to contain the mess and smell of a cat litter box, most of these items are industrial in nature and are made from inexpensive plastics and card board which is often considered unsightly for use in a living room area.

In reviewing the prior art, there are a number of cat box litter covers that are primarily decorative in nature and mimic building structures. For example, the following U.S. Design Patents resemble decorative houses: U.S. Des. Pat. No. 425,674 issued to D. Dykens resembles a gingerbread house; U.S. Des. Pat. No. 347,304 issued to A. Hellem resembles a modern home with clean, simple designs; U.S. Des. Pat. No. 319,115 issued to R. White resembles a country home; U.S. Des. Pat. No. 230,285 issued to J. Dilley resembles a Swiss Chalet; and, U.S. Des. 298,672 issued to W. Herbst resembles a clapboard home with shutters and cedar shake roof. U.S. Des. Pat. No. 276,752 issued to S. Kinzie and U.S. Des. Pat. No. 228,558 issued to R. Brickel both resemble barns. U.S. Pat. No. 5,337,700 issued to B. Toft even resembles a castle. However, none of these building structure type cot litter box covers come as one simple and light enclosure, adaptable to any size and shape littler box, and with the option for decorative outer visible surfaces.

Two U.S. Design patents disclose collapsible structures intended to enclose and conceal a cat litter box are U.S. Des. 245,191; U.S. Des. 311, 795. Although it might be convenient to collapse and store a litter box, nonetheless, it would not appear that either of these structures have features which will allow the owner to merely surround any shape and size littler box with a decorative screen.

There are also prior U.S. patents which illustrate cat litter box chambers which may be collapsed by the owner: U.S. Pat. No. 5,865,140 issued to S. McGivern; U.S. Pat. No. 3,890,930 issued to M. Clark; U.S. No. 4,792,082 issued to G. Williamson, U.S. Pat. No. 5,027,748 issued to R. Wolak; U.S. Pat. No. 5,046,457 issued to R. Ashcroft; U.S. Pat. No. 5,465,686; U.S. Pat. No. 5,730,085 issued to C. Santoiemmo; and, U.S. Pat. No. 5,014,649 issued to M. Taft. None of these devices comprise one unit, light to hold, adaptable to the size and shape of any box, and with the option for a decorative outer surface.

In U.S. Pat. No. 3,581,708 issued to J. Beck is disclosed a cat litter box which is shaped like a house with a gabled roof and has a front door flap. U.S. Pat. No. 4,348,982 issued to J. Selby discloses the use of a cat litter chamber intended to more fully prevent the escape of waste smells. This particular device is not only disposable, but also has filters disposed in apertures in the sidewalls of the device to prevent smells from escaping therefrom.

U.S. Pat. No. 4,181,095 issued to M. Sylogye discloses the use of folding screen panels which are hinged so that the screen may be easily collapsed. However, the screen device is not provided with stabilizing wires to prevent the animal from collapsing the screen, or with an option for placing the litter box on top of a panel of the screen for self stability of the decorative screen. U.S. Pat. No. 4,858,561 issued to H. Springer discloses the use of a portable and collapsible pet enclosure which is zippered at one end to allow the litter box to be changed. U.S. Pat. No. 5,566,640 issued to J. Krumrei shows the use of a maze type of litter box container which is capable of creating an isolated or dead air space to create an air lock chamber to prevent odors from escaping therefrom. U.S. Pat. No. 5,582,133 issued to K. Zimmerlin discloses the use of a cat litter pan enclosure with a smaller pan within a larger tub to prevent a cat from spraying onto adjoining walls and drapes when it urinates. And finally, U.S. Pat. No. 5,329,879 issued to R. Walton discloses the use of a cat litter box suitable for use with cats and kittens alike because it is provided with a small ramp at the entrance of the device for the kitten to climb up onto to enter the device. A plastic line may be held in place by an upper portion which clamps onto a lower pan.

Thus, nowhere in the prior art is seen a decorative cat litter box enclosure wherein the user contour the enclosure according to the shape and size of the litter box, and stabilize the enclosure with either support and/or stabilizing wires at the upper corners of the enclosure, or by placing the box on top of flap(s) of the unit.

### SUMMARY OF THE INVENTION

The present invention consists of a decorative litter box enclosure having at least three upstanding sidewall sections. In one preferred embodiment, the outside walls have at least one base flop attached therein for securing under the litter box. In another preferred embodiment, there is a support and/or stabilizing means which can be diagonally secured across two side walls stabilizing the standing enclosure from being misshapen or dislodged by a rambunctious animal. Another preferred embodiment includes a support and/or stabilizing means in the upper corners of the enclosure. In yet another preferred embodiment, the enclosure can have a combination of any of a support and/or stabilizing means in the upper corners of the enclosure, at least one base flap tucked under the litter box, and/or a support and/or stabilizing means diagonally securing two side walls. Further, the exterior portion of the upstanding sidewall sections can be decorated. The device can be made from any material which can contain urine from escaping onto a floor surface, such as corrugated rigid plastic or other copolymer, or can even be made from a paper product such as a durably coated corrugated cardboard.

The decorative exterior of the upstanding sidewall sections may include, but is not limited to, a simple and solid colored unit to elaborately painted walls which can blend in with any decor, from art deco, to traditional, modern, Asian, etc. In any case, since the decorative enclosures are disposable, inexpensive, easily manipulated, simple, and less cumbersome than other enclosures, the user can change the room decor and purchase new decorative enclosures to match the new room decor as desired. Or, as the panels wear or get dirty through use, the owner can simply purchase additional enclosures.

In one preferred embodiment, the improved cat litter decorative enclosure may be made with simple support and/or stabilizing means that can be made from, but are not limited to, wood, metal, or plastic of any kind. Such a support and/or stabilizing means con further comprise, but is not limited to, miniature hook and loop fasteners, hooks, pegs or snap means, velcro assemblies, or any other commonly used mounting means found in the relevant art of attachment devices. Such a support and/or stabilizing means would be useful in situations where the cats using the litter box interact with the sides of the litter box thus brushing against the enclosure. Moreover, the support and/or stabilizing means can be produced in various colors to match the outer decorative sides of the upstanding side walls so as to blend in with the overall aesthetic appearance of the enclosure. As an additional feature of the device, the unit should be made of a corrugated material that may be readily folded or taken apart so that the device may be collapsed for easy transportation from room to room and will enclose any shape or size target area.

It is further anticipated, that although none of the embodiments shown herein has a top, a top may be easily designed and provided where the owner desires a top to the screen. However, it should be noted that creating such an enclosure may not be desirable because many animals can kick up dust and debris from the litter which may be inhaled and cause upper respiratory problems. Nonetheless, where desired, the top may be a simple rectangular tray or even a gabled roof structure, which may be more aesthetically pleasing to the user thereof.

### OBJECTS OF THE INVENTION

Thus, it is one primary object of the present invention to provide a cat litter box enclosure or chamber having at least three upstanding sidewalls which are provided with decorative outside exposures.

It is yet an additional primary object of the present invention to provide a cat litter box enclosure or chamber having at least three upstanding sidewall members which are provided on their upper surface with a means for support and/or stabilizing the enclosure panel.

It is still a further primary object of the present invention to provide a cat litter box enclosure or chamber having at least three upstanding sidewalls wherein the support and/or stabilizing means consists of simple support and/or stabilizing means, such as miniature hook and loop fasteners, hooks, pegs or snap means or any other commonly used mounting means.

Yet a further primary object of the present invention to provide a cat litter box enclosure or chamber having at least three upstanding sidewalls wherein the support and/or stabilizing means can be color coordinated to the decorative outside portions of the upstanding sidewalls.

Another primary object of the present invention is to provide a cat litter box enclosure having at least three upstanding sidewalls wherein the decorative outside portions of the sidewalls may consist of a wide variety of decorative textures, colors, and scenes such as solid color, original works of art, hand painted scenes and the like.

Additionally it is primary object of the present invention to provide a cat litter box enclosure or chamber having at least three upstanding sidewall members or sidewalls wherein the side walls may be made from a corrugated material which can be contoured to encompass any size and shape litter box.

Still another primary object of the present invention is to provide a cat litter box enclosure having at least three upstanding sidewall members wherein the side walls are created from one integral unit.

Another primary object of the present invention is to provide a cat litter box enclosure having at least three upstanding sidewall members wherein the outer sidewalls may be extended to form at least one base flap for support of the enclosure.

Yet another primary object of the present invention is to provide a cat litter box enclosure having at least three upstanding sidewall members with a combination of support and/or stabilizing means and base flap(s) for support and/or stabilizing the enclosure.

It is yet an additional primary object of the present invention to provide a cat litter box enclosure or chamber having at least three upstanding sidewall members which is light, easily manipulated, and inexpensive.

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is a interior elevational view of one embodiment of the present invention showing it before custom assembly.

FIG. 2 is a front perspective view of one embodiment of the present invention showing the customized assembly.

FIG. 3 is a front perspective view of one embodiment of the present invention showing the use of base flops and support and/or stabilizing means.

FIG. 4 is a broken away front elevational view of the cross section of one embodiment of the support and/or stabilizing means of the present invention.

FIG. 5 is a front elevational view of one type of support and/or stabilizing means for the present invention.

FIG. 6 is a top elevational view of an embodiment of the present invention having three upstanding sidewall sections.

### DETAILED DESCRIPTION OF THE DRAWINGS

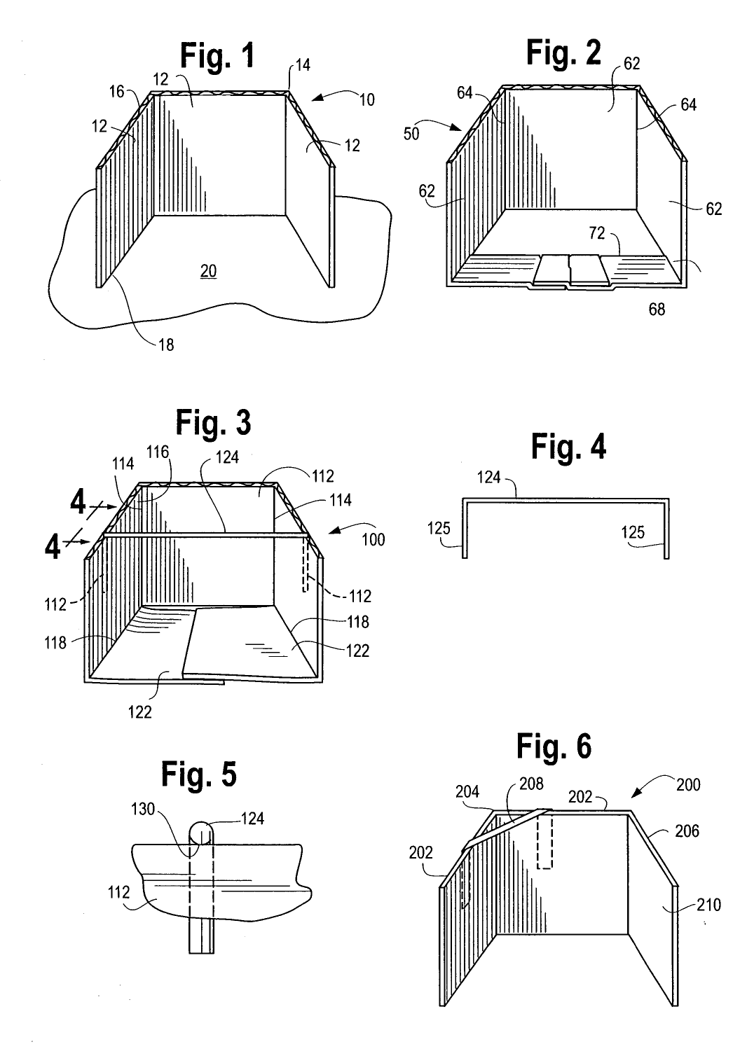

Shown now in FIG. 1 is an interior elevation view of a preferred embodiment of the decorative animal litter box enclosure 10, before customized manipulation, which has at least three upstanding sidewall sections 12 which can be assembled by the user along any one of the fold lines 14 of the enclosure 10. The enclosure 10 has an upper portion 16 and a lower portion 18. The lower portion 18 interacts with the floor 20.

FIG. 2 shows or illustrates another preferred embodiment of the present invention wherein an interior perspective view of the decorative animal litter box enclosure 50 is shown, after customized assembly thereof, which is provided with three upstanding sidewall sections 62 which have been created by the user along dual fold lines 64 of the enclosure 10. In this particular preferred embodiment, the lower portion 68 of one of the upstanding sidewall sections 62 lies directly adjacent to, and is integral with, a base flap 72 which can be tucked under a standard litter box for stability of the entire device since it is well known in the art that some cats are very frisky. In this preferred embodiment the base flap 72 is provided with interlocking terminal tab 74 designed to receive opposing terminal tab 74

FIG. 3 shows yet another preferred embodiment of the present invention. FIG. 3 is a interior perspective view of the improved decorative animal litter box enclosure 100, after assembly of the device, which has three upstanding sidewall sections 112, that have been created by the user along fold lines 114, two base flaps 122 which have been folded along the lower portion 11 8 of two of the upstanding sidewall sections 112 and may be tucked under a standard litter box to provide rigidity and stability for cat litter box enclosure 100. For additional stability, a support and/or stabilizing means 24 is suspended along the upper portion 116 of two of the upstanding sidewall sections 112, along the open side of the present invention. Support and/or stabilizing means 124 may be any color to give the decorative cat litter box enclosure 110 an aesthetically pleasing look.

FIG. 4, a broken away elevated cross-section of a preferred embodiment of the support means is shown via cross section A-A shown in FIG. 3. In this view, a section 112 is provided with a channel 130 in the corrugation of the sidewall 112 which is adapted to receive a rigid support and/or stabilizing means 124. The support and/or stabilizing means 124 is preferrably made from a metal rod which extends to a distance of 4″ to 8″ in the vertical channels of the upstanding sidewalls 112.

FIG. 5 shows a front elevational view of support and/or stabilizing means 124 shown in FIG. 3. Opposing legs 125 are intended to extend vertically downward into the corrugated channels of upstanding opposing sidewall sections 112 as shown in FIG. 3. It should be noted that the slender elongate rod 124 is substantially U shaped.

FIG. 6 is another preferred embodiment of the decorative cat litter box enclosure 200. FIG. 6 is a top elevation view of the decorative cat litter box enclosure 200 having three upstanding sidewall sections 202 created along fold lines 204. In this preferred embodiment, the upper portion 206 of the enclosure 200 has a support and/or stabilizing means 208. At least one support and/or stabilizing means 208 may be provided. The upstanding sidewall sections 202 have an exterior 210 and an interior 212 portion. The exterior portion 210 of the upstanding sidewall sections 202 may be decorated so that the decorative cat litter enclosure 200 is aesthetically pleasing.

The preferred embodiment described in FIGS. 4 and 5 for the support and/or stabilizing means 124 of FIG. 3 can be used for the configuration of the support and/or stabilizing means 208 of FIG. 6. It should also be noted that the decorative cat litter box enclosure 10, of FIG. 1, can be used with either at least one base flap or at least one support and/or stabilizing means, or a combination of the two.

Further, it is believed that an appropriate dimension for the height of the upstanding sidewall sections of the decorative cat litter box enclosure 10 would be at least 8″ and at most 36″ to ensure that the cat litter box is well hidden. The support and or support and/or stabilizing means 124, of FIG. 5, and support and/or stabilizing means 108, of FIG. 6, can be disassembled easily and quickly so that the enclosure 10 can be collapsed and stored or disposed of.

Moreover, a support and/or stabilizing means 124, of FIG. 5, is preferably a rod, made from wood, plastic, aluminum or steel, and the like. Upstanding sidewall sections 62 and/or base flops 72, of FIG. 2, can be made from a corrugated plastic or other copolymeric material, a piece of cardboard coated with a plastic or copolymeric substance that is either sprayed on, or a plastic sheeting secured either with an adhesive or by melting or fusing the sheeting to a heavy paper or particulate board thus providing a wide variety of inexpensive materials which may be utilized to practice the present invention.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

### PARTS LIST

FIG. 1

10—decorative animal litter box enclosure

12—upstanding sidewall sections

14—fold line

16—upper portion

18—lower portion

20—ground

FIG. 2

50—decorative animal litter box enclosure

62—upstanding sidewall section

64—fold line

68—lower portion

72—base flap

74—terminal tab

FIG. 3

100—decorative animal litter box enclosure

112—upstanding sidewall section

114—fold line

116—upper portion

118—lower portion

122—base flap

124—support and/or stabilizing means

FIG. 4

112—upstanding sidewall section

124—support and/or stabilizing means

130—channel

FIG. 5

112—upstanding sidewall sections

124—support and/or stabilizing means

125—opposing legs

FIG. 6

200—decorative animal litter box enclosure

202—upstanding sidewall section

204—fold line

206—upper portion

208—support and/or stabilizing means

210—exterior portion

I claim:

1. A litter box enclosure comprising;
a substantially rigid thin flexible corrugated sheet having at least three upstanding sidewall sections assembled along customized fold lines;
an upper, lower, interior, and exterior portion wherein the exterior portion is decorated and means for stabilizing a least two of the upstanding sidewall sections.

2. A litter box enclosure of claim 1, wherein the stabilizing means comprises at least one base flap adjacent to the lower portion of an upstanding sidewall section.

3. A litter box enclosure of claim 2 wherein the stabilizing means further is provided with at least one interlocking tab.

4. A litter box enclosure of claim 1, wherein the sheet is composed of a material selected from one or more groups of the following material; plastic or other copolymeric material, paper, wood, and metal.

5. A litter box enclosure of claim 1, wherein the upper portion has at least one means for stabilizing the upstanding sidewalls.

6. The means for stabilizing the unit of claim 5, wherein the stabilizing means is composed of a rigid material selected from one or more groups of material; paper, plastic or other copolymeric material, wood, and metal.

7. A litter box enclosure of claim 1, wherein the distance from the upper portion to the lower portion is substantially 6″ to 36″ in height.

8. The litter box enclosure of claim 1 wherein the stabilizing means comprises an elongate length of slender metal rod.

9. The litter box enclosure of claim 8 wherein the slender metal rod has a substantially a u shape.

10. The litter box enclosure of claim 1 wherein the stabilizing means comprises a length of miniature hook and loop fastener secured between two of the upstanding sidewalls.

11. The litter box enclosure of claim 1 wherein the stabilizing means comprises two opposing base flops which each lie adjacent one upstanding side wall, and which, when the enclosure is fully assembled, will overlap one another.
